(19) United States
(12) Patent Application Publication
(10) Pub. No.: US 2002/0080415 A1
(43) Pub. Date: Jun. 27, 2002

(54) Communication apparatus for forwarding received data

(76) Inventors: Naoto Akimoto, Ibaraki (JP); Takehiro Yoshida, Tokyo (JP); Toshiyuki Takano, Ibaraki (JP); Hiroshi Fukada, Tokyo (JP); Yasuhiro Matsumoto, Ibaraki (JP); Shigeyuki Sugiyama, Kanagawa (JP); Yasuo Komada, Ibaraki (JP); Noriaki Seto, Ibaraki (JP)

Correspondence Address: MORGAN & FINNEGAN, L.L.P., 345 PARK AVENUE, NEW YORK, NY, 10154, US

(21) Appl. No.: 10/006,530

(22) Filed: Dec. 5, 2001

(30) Foreign Application Priority Data
Dec. 12, 2000 (JP) 2000-377047
Dec. 27, 2000 (JP) 2000-399017

(51) Int. Cl. H04N 1/00

(52) U.S. Cl. 358/402

(57) ABSTRACT

In the case of forwarding data received via a circuit by electronic mail, it is possible to forward it to a plurality of forwarding destinations. In that case, it is possible to register a format on forwarding for each forwarding destination. For instance, when attaching received images to the electronic mail, whether to attach all the images or just one page, and an image format for the sake of attachment can be registered. In addition, it is possible, in the case where the data is received based on the ITU-T T. 37 recommendation, to register whether to delete an attachment file received and transmit only the text, transmit only the attachment file or transmit both the text and the attachment file. Moreover, a forwarding method in the case where the forwarding destination is a mobile terminal can also be registered.

### BACKGROUND OF THE INVENTION

1. Field of the Invention

The present invention relates to a communication apparatus for forwarding received data as electronic mail, a control method thereof and a storage medium storing a program for controlling the communication apparatus.

2. Related Background Art

In the past, a system for attaching a facsimile-received document received from a public network to electronic mail and forwarding it to a network terminal on a LAN was invented.

In such a system, the received documents were forwarded to one specific representative terminal as their destination such as a computer used by a manager, and they were not forwarded to a plurality of terminals.

In addition, facsimile communication via the Internet was recommended by the ITU-T T. 37 recommendation, so that it became also possible to perform the facsimile communication between facsimile apparatuses via the Internet.

### SUMMARY OF THE INVENTION

An object of the present invention is to allow received information to be forwarded (distributed) by electronic mail to a plurality of apparatuses.

Another object of the present invention is to allow forwarding meeting a request of each forwarding destination to be performed in the case of forwarding (distributing) the received information by the electronic mail to the plurality of apparatuses.

A further object of the present invention is to allow forwarding suited to a type of apparatus of each forwarding destination to be performed in the case of forwarding (distributing) the received information by the electronic mail to the plurality of apparatuses.

A still further object of the present invention will be clarified by the following specification and drawings.

### BRIEF DESCRIPTION OF THE DRAWINGS

FIG. 1 shows a block diagram of communication terminal equipment of a first embodiment;

FIG. 2 is a block diagram of a configuration example of a network on which the communication terminal equipment in FIG. 1 is placed;

FIG. 3 is a diagram describing an example of a table for storing destination information when distributing a document received by the communication terminal equipment in FIG. 1 to a client on a LAN;

FIG. 4 is a diagram describing an example of a table for storing an image format used as an alternative in setting a color conversion format information of the destination information table in FIG. 3;

FIG. 5 is a diagram describing an example of a table for storing an image format used as an alternative in setting a monochrome conversion format information of the destination information table in FIG. 3;

FIG. 6 is a flowchart of a received document distribution process executed by the communication terminal equipment in FIG. 1;

FIG. 7 is a flowchart of a conversion process for images of all pages in a step S606 in FIG. 6;

FIG. 8 is a flowchart of a cover page conversion process in a step S607 in FIG. 6;

FIG. 9 is a block diagram of a facsimile apparatus according to second and third embodiments;

FIG. 10 is a diagram showing examples of “Received e-mail address”, “Forwarding destination” and “Object to be forwarded” registered in correspondence to memory box numbers in the second embodiment;

FIG. 11A is a diagram showing examples of “Received e-mail address”, “Forwarding destination” and “Sender terminal” registered in correspondence to memory box numbers in the third embodiment;

FIG. 11B is a diagram showing examples of objects to be sent registered in correspondence to the types of the sender terminals in FIG. 11A;

FIG. 12 is a flowchart showing operation of the second embodiment;

FIG. 13 is a flowchart showing the operation of the second embodiment;

FIG. 14 is a flowchart showing the operation of the second embodiment;

FIG. 15 is a flowchart showing the operation of the third embodiment; and

FIG. 16 is a flowchart showing the operation of the third embodiment.

### DETAILED DESCRIPTION OF THE PREFERRED EMBODIMENTS

(First Embodiment)

Embodiments of the present invention will be described in detail hereafter by using the attached drawings.

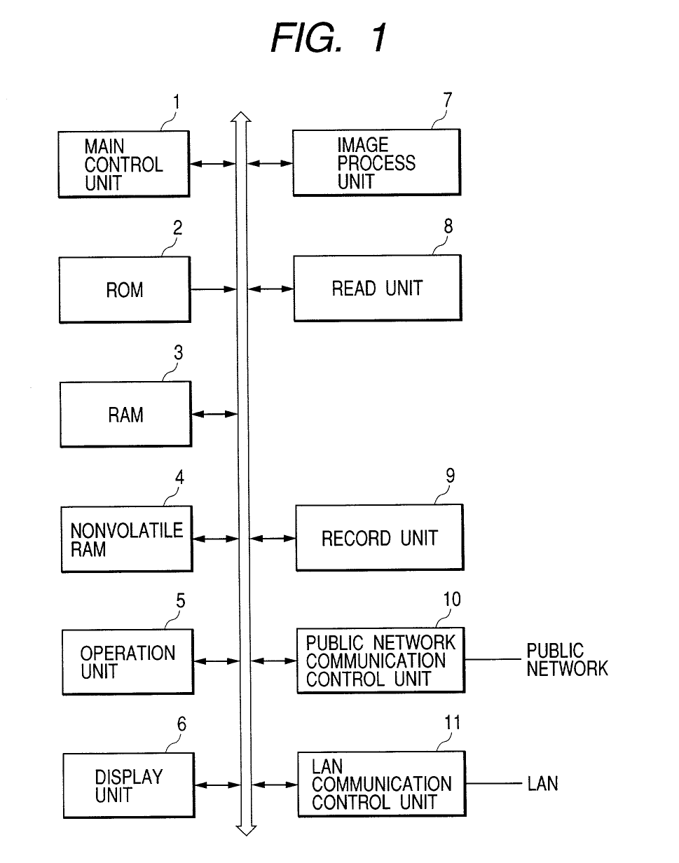

FIG. 1 is a block diagram showing an overview configuration of communication terminal equipment involved in a first embodiment of the present invention.

In the communication terminal equipment in FIG. 1, a main control unit 1 controls the entire communication terminal equipment, that is, a RAM 3, a nonvolatile RAM 4, an operation unit 5, a display unit 6, an image process unit 7, a read unit 8, a record unit 9, a public network communication control unit 10 and a LAN communication control unit 11 according to a program stored in a ROM 2.

The RAM 3 stores monochrome binary image data and color multivalued image data read by the read unit 8, image data wherein these are JPEG-compressed in the image process unit 7, monochrome binary data outputted from a telephone line via the public network communication control unit 10, color JPEG-compressed data, color multivalued data wherein it is expanded, and color binary data binarized to allow further recording in the record unit 9. In addition, the RAM 3 stores management information for managing the above data, work information for apparatus operation, and status information of the record unit.

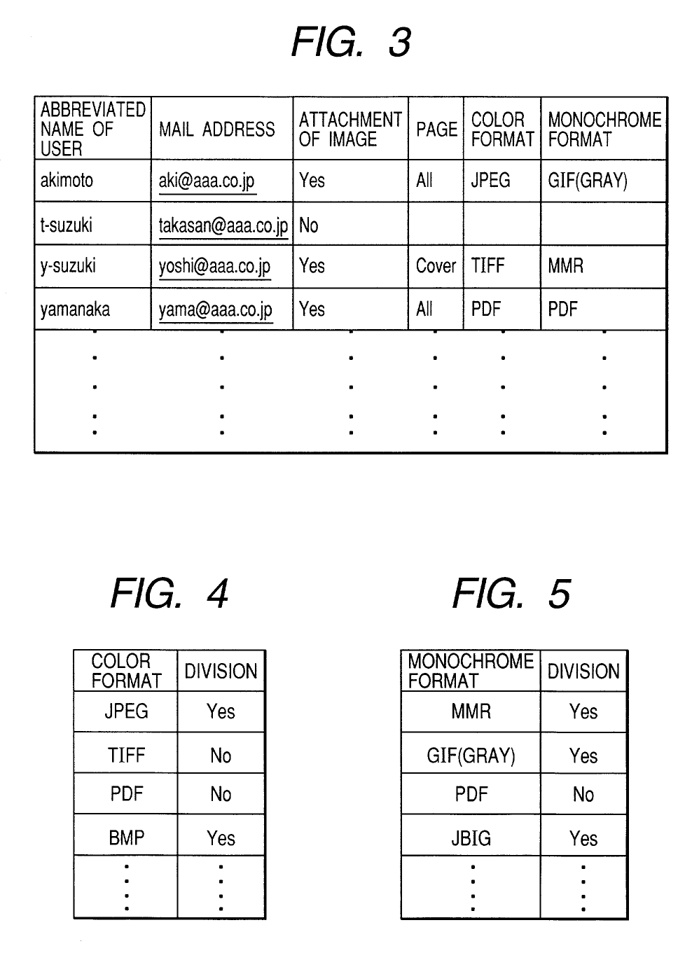

The nonvolatile RAM 4 is an SRAM with battery backup, and stores the data unique to the apparatuses such as telephone numbers and client abbreviations and information on apparatus setting by clients. In this embodiment, an area in FIG. 3 mentioned later is newly provided, which stores for each client detailed settings such as an electronic mail address for distributing a received facsimile document, whether or not to attach an image on distribution, specification of an attached page and so on.

The operation unit 5 is comprised of a start key for transmission, reception and so on, a mode key for specifying a communication mode such as color and monochrome in a transmitted image, a copy key for duplication, a stop key for stopping operation, a registration key for registering with a one touch key, an error release key for releasing an error and a LAN distribution key for registering detailed settings when distributing a received facsimile document to clients on a LAN.

The display unit 6 is comprised of a dot matrix type LCD and an LCD driver, and performs various types of display based on control from the main control unit The image process unit 7 performs image processing such as compression of the monochrome binary data read by the read unit 8, JPEG-compression of the color multivalued data, compression/expansion of monochrome binary data for sending and receiving images to and from the other party of communication, expansion of the monochrome binary data when recording the images in the record unit 9, expansion of color JPEG images and so on, and stores the data in the RAM 3. In addition, it executes a process of converting the monochrome binary data and the color JPEG image data received from the other party and stored in the RAM 3 into image formats specified by the clients for the purpose of distributing the data by attaching it to electronic mail, such as JPEG (Joint Photographic Experts Group), TIFF (Tagged Image File Format), PDF (Portable Document Format), BMP (Bit Map), MMR (Modified Modified READ Code), JBIG (Joint Bi-Level Image Experts Group) and so on.

The read unit 8 is comprised of a DMA controller, a CCD or a contact type image censor (CS), a general purpose IC and so on, and sends to the RAM 3 or the image process unit 7 the data read by using the CCD or the CS based on the control of the main control unit 1.

The record unit 9 is comprised of the DMA controller, a thermal head or a BJ printer head (Bubble Jet Printer Head) of B4/A4 size, a general purpose IC and so on, and is controlled by the main control unit 1 to extract record data stored in the RAM 3 and print it out as a hard copy.

The public network communication control unit 10 is comprised of V. 34, V. 17, V. 29, V. 27 ter and V. 21 (H, L) modems, a clock generation circuit connected to these modems, an NCU and so on, and modulates send data stored in the RAM 3 and outputs it to the telephone line (public network) based on the control of the main control unit 1. In addition, in compliance with the recommendations of the ITU T. 30, it implements monochrome/color facsimile communication, and demodulates the images received from the telephone line to store them in the RAM 3.

The LAN communication control unit 11 is connected as a physical layer to a network circuit such as the Ethernet, and implements a process of distributing a received document to the clients on the network by performing TCP/IP (Transmission Control Protocol/Internet Protocol) protocol, MIME (Multi-purpose Internet Mail Extensions) conversion (Base64 for instance) or SMTP (Simple Mail Transfer Protocol) for the sake of conducting electronic mail communication.

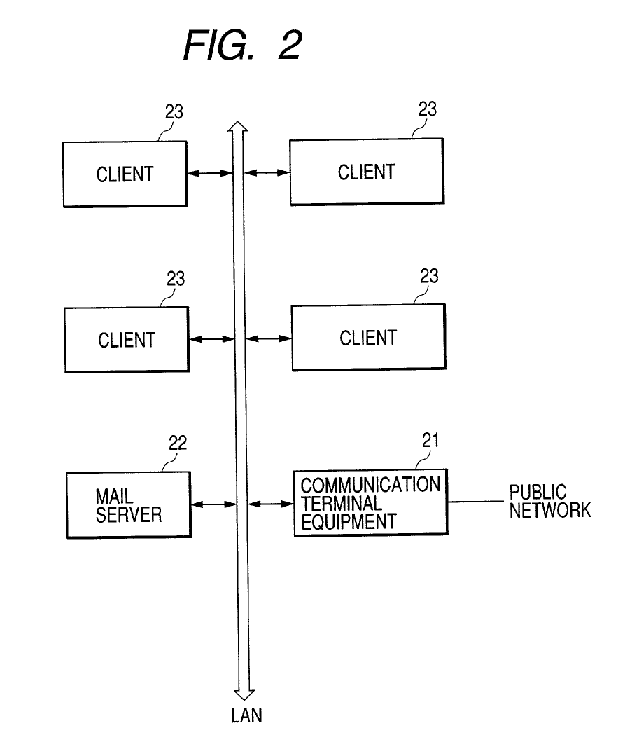

FIG. 2 is a block diagram of a configuration example of the network on which the communication terminal equipment in FIG. 1 is placed.

In the network in FIG. 2, communication terminal equipment 21 in FIG. 1 is connected to a mail server 22 and a plurality of clients 23 via the LAN. The electronic mail is transmitted in an accumulated distribution type transmission form wherein it is accumulated in the mail server 22 via the communication terminal equipment 21 once and then distributed to destinations. The clients make an inquiry from the respective clients 23 to the mail server 22 over receipt of the electronic mail addressed to their terminal clients, and when the electronic mail addressed to them is accumulated in the mail server 22, they receive it from the mail server 22 and notify their terminal clients thereof.

FIG. 3 is a diagram describing an example of a table for storing destination information when distributing to the client on the LAN the monochrome or color document facsimile-received from the public network by the communication terminal equipment in FIG. 1.

The table in FIG. 3 is placed in the nonvolatile RAM 4, and the information of this table is configured to be set from the operation unit 5. For instance, a LAN distribution key is allocated for table registration, and when this key is pressed, operations such as adding a client to this table, changing the settings and deleting a client can be performed. In FIG. 3, the information to be stored includes client and user abbreviations for the sake of identifying distribution registrants, electronic mail addresses of the destinations, image attachment information on whether or not to attach received images to the electronic mail, document page information on whether to attach all pages or only a top page in the case of attaching the images, color conversion format information for specifying a document conversion format when attaching a color document and monochrome conversion format information for specifying the document conversion format when attaching a monochrome document.

FIG. 4 is a diagram describing an example of a table for storing the image format used as an alternative in setting a color conversion format information of the destination information table in FIG. 3.

The table in FIG. 4 is stored in the ROM 2 or a RAM 3, and stores a document format that can be converted when distributing the color document received by the communication terminal equipment in FIG. 1 on the LAN as an attachment file.

The image formats stored in the table in FIG. 4 can be converted into the JPEG, TIFF, PDF and bit map formats according to this embodiment. In addition, this table stores division information on, when converting the image in each color image format, whether to create the attachment file by dividing it on each page or as one document that is not divided.

FIG. 5 is a diagram describing an example of a table for storing the image format used as an alternative in setting monochrome conversion format information of the destination information table in FIG. 3.

The table in FIG. 5 is stored in the ROM 2 or the RAM 3, and stores a document format that can be converted when distributing as the attachment file the monochrome document received from the public network by the communication terminal equipment in FIG. 1 on the LAN.

The image format stored in the table in FIG. 5 can be converted into the MMR, GIF (gray scale), PDF and JBIG formats according to this embodiment. In addition, this table stores the division information on, when converting the image in each monochrome image format, whether to create the attachment file by dividing it on each page or as one document that is not divided.

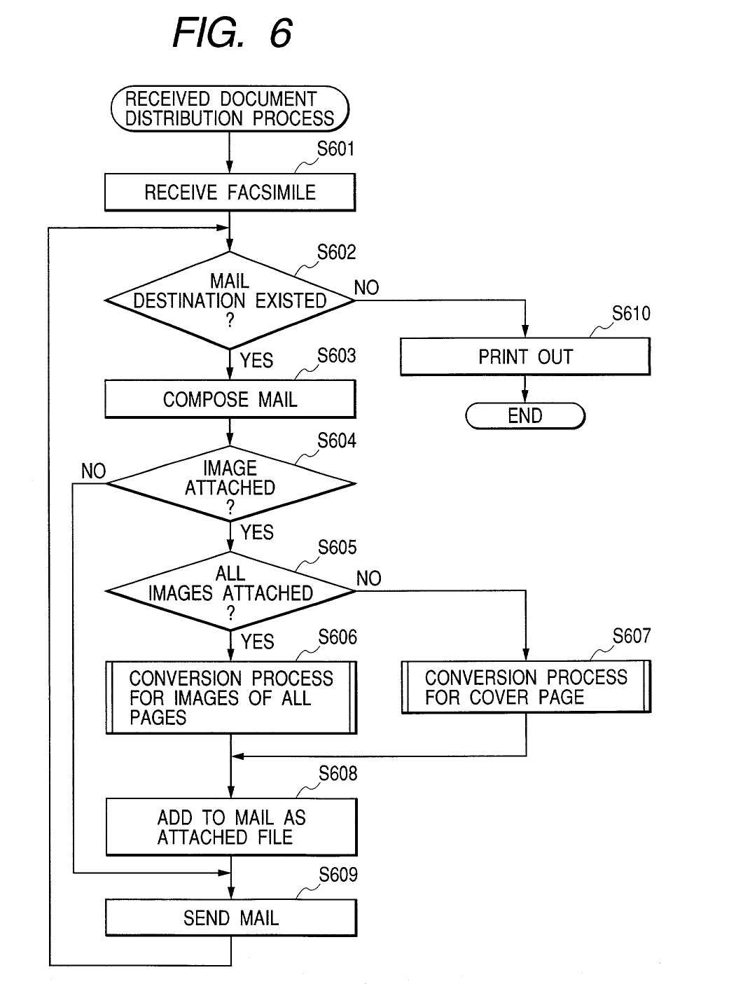

FIG. 6 is a flowchart of a received document distribution process executed by the communication terminal equipment in FIG. 1.

First, it receives an image file from the other facsimile via the public network in compliance with the ITU T. 30 recommendation (step S601). The image file is comprised of pages of monochrome images or pages of color images. The monochrome images are encoded in one of the formats of MH, MR, MMR and JBIG, and the color images are encoded in the JPEG format and received. This communication terminal equipment retains the encoded data of each page in the RAM 3 together with color information of monochrome/color and page information such as the information on an encoding system.

Next, it determines from the contents set in a destination information table (FIG. 3) whether or not one or more destination clients of the image file are registered in the table (step S602), and when one or more clients are registered therein, it creates a header portion and text of the electronic mail for transmission (step S603). To create the header portion, it sets the information stored in a mail address column of the destination information table in a To field indicating the destination. As for a Subject field indicating a heading, it is also possible to store character information indicating the receipt of the facsimile such as “Fax Received” in the ROM 2 in advance and set it therein. In addition, a text field can have either the above information indicating the receipt of the facsimile or nothing in particular set therein.

In a subsequent step S604, it determines whether or not an image attachment setting of the destination client is “Image attached based on the destination information”. As a result of determination in the step S604, when it is “Not attached”, it proceeds to a step S609. On the other hand, when it is “Image attached”, it determines whether or not the attached page setting of the destination client is all pages based on the destination information table (step S605).

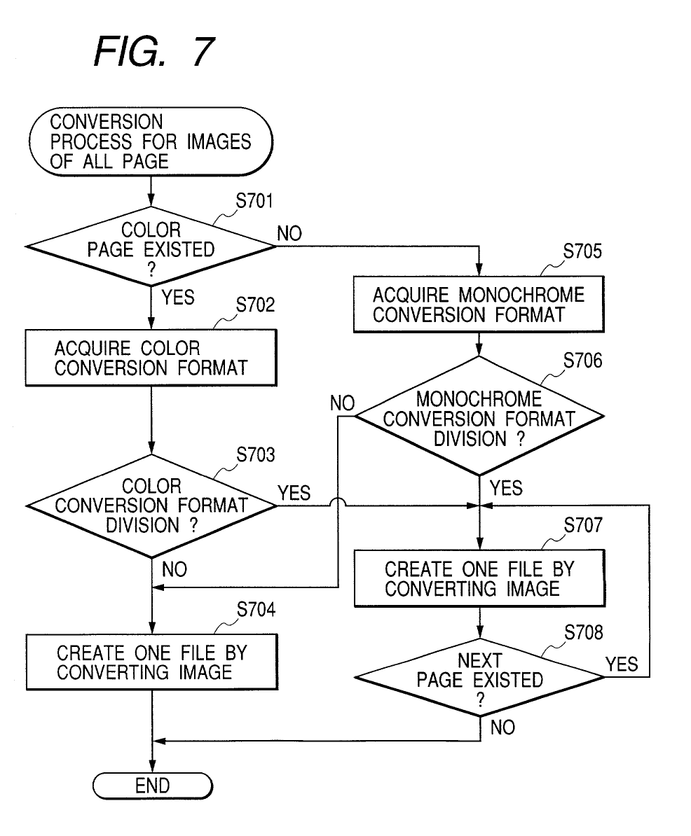

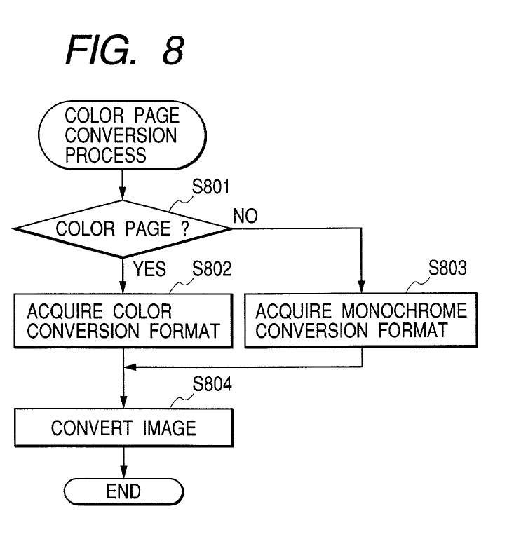

As a result of determination in the step S605, when the attached page setting is “All pages”, it executes a conversion process for images of all pages in FIG. 7 to convert the received images into the image format specified by the client (step S606), and when the attached page setting is not “All pages”, it executes a conversion process for cover page in FIG. 8 mentioned later to convert only the top page of the received images into the image format specified by the client (step S607).

In a step S608, the images created in the above conversion process for images of all pages (FIG. 7) or the conversion process for cover page (FIG. 8) are attached as the attachment file to the electronic mail. To be more specific, the MIME system uses an encoding system such as Base64 to convert the images that are a binary file into character strings sendable by the electronic mail, which are described following the text of the mail.

In a subsequent step S609, it sends the created electronic mail by SMTP via the mail server 22 on the LAN to the destination clients 23 registered in the destination information table, and then it executes the following process in the step S602 and executes a distribution process to a next destination.

As a result of the determination in the step S602, if the mail is sent to all the destinations registered in the destination information table and no more mail destination is left, it prints out the received images from the record unit 9 and erases the images from the RAM 3 (step S610) to finish this process.

FIG. 7 is a flowchart of the conversion process for images of all pages in a step S606 in FIG. 6.

First, it determines whether or not there is a color page from image information on each page of the received document (step S701), and if there is even one color page, it acquires the color conversion format information of the destination clients based on the destination information table (FIG. 3) (step S702), and it determines whether or not a division setting of the color conversion format acquired in the step S702 is “Divided” based on the color conversion format table (FIG. 4) (step S703).

As a result of the determination in the step S703, if the division setting is “Not divided”, the image process unit 7 creates one file by converting all the pages of the received images into the image format specified by the client (step S704) and finishes this process.

As a result of the determination in the step S703, if the division setting of the acquired color conversion format is “Divided”, the image process unit 7 first creates one file by converting the top page of the received images into the image format specified by the client (step S707), and subsequently determines whether or not there is a next page to the received images (step S708).

As a result of the determination in the step S708, if there is the next page, it returns to the step S707, and creates one file by converting the next page of the received images into the image format specified by the client again. It repeats this process until there is no more page and finishes this process when there is no more page.

As a result of the determination in the step S701, if there is no color page in the received document, it acquires the monochrome conversion format information (encoding system) of the destination clients based on the destination information table (step S705), and determines whether or not the division setting of the monochrome conversion format acquired in the step S705 is “Divided” based on the monochrome conversion format table (FIG. 5) (step S706).

As a result of the determination in the step S706, if the division setting is “Not divided”, the image process unit 7 creates one file by converting all the pages of the received images into the image format specified by the client (step S704) and finishes this process.

As a result of the determination in the step S706, if the division setting of the acquired monochrome conversion format is “Divided”, the image process unit 7 first creates one file by converting the top page of the received images into the image format specified by the client (step S707).

As a result of the determination in the step S708, if there is the next page, it returns to the step S707, and creates one file by converting the next page of the received images into the image format specified by the client again. It repeats this process until there is no more page and finishes this process when there is no more page.

FIG. 8 is a flowchart of a cover page conversion process in the step S607 in FIG. 6.

First, it determines whether or not the first page of the received document is the color page (step S801). As a result of the determination in the step S801, if it is the color page, it acquires the setting of the color conversion format information (encoding system) of the clients to be distributed based on the destination information table (step S802), and the image process unit 7 creates one file by converting the first page of the received images into the conversion image format acquired in the step S802 (step S804) and finishes this process.

As a result of the determination in the step S801, if the first page of the received document is not the color page, it acquires the setting of the monochrome conversion format information of the clients to be distributed based on the destination information table (step S803), and the image process unit 7 creates one file by converting the first page of the received images into the conversion image format acquired in S803 (step S804) and finishes this process.

While the above embodiment is an example wherein the process of searching the electronic mail destination information table and sending the converted images by attaching them to the mail is repeated until there is no more destination, it is also possible, as a deformed example, to broadcast the same mail to the clients to be distributed that are setting the same attached image format. In this case, the time for image conversion processing can be reduced.

Moreover, it is also possible to convert the received images into each format in advance and select the attached images according to the specification of the client when creating the electronic mail, whereby the entire processing time can be reduced in the case where there are a large number of the clients to be distributed.

As described in detail above, it is possible, according to this embodiment, to distribute facsimile data received from the public network to a plurality of registered clients. In addition, as detailed specification for each client such as whether or not there is the attachment file, specification of the attached pages and specification of the format of the attached images is possible, it allows settings meeting the needs of the clients to be made so that operability is markedly improved.

(Second Embodiment)

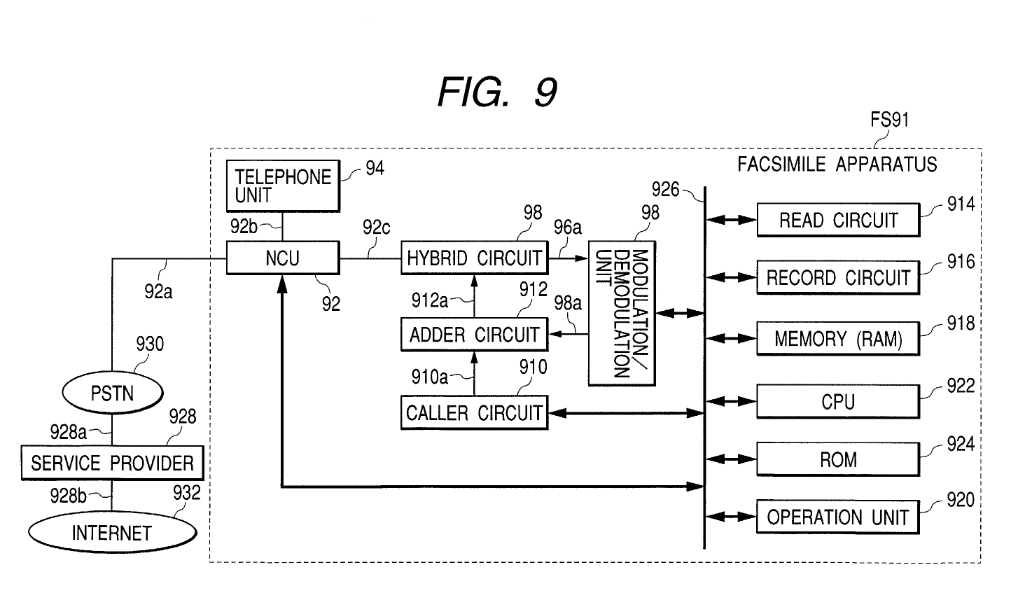

FIG. 9 is a block diagram showing a facsimile apparatus FS 91 according to a second embodiment of the present invention.

In the facsimile apparatus FS 91, for the sake of using a telephone network for data communication and so on, an NCU (network control unit) 92 connects its line 92a to a terminal to perform connection control of a telephone exchange network, perform a switch to a data communication line and maintain a loop. In addition, the NCU 92 connects the telephone line 92a to a telephone unit (CML off) and to the facsimile apparatus (CML on) under control of the bus 926. Moreover, the telephone line 92a is connected to the telephone unit 94 in a normal state.

A hybrid circuit 96 separates transmission system signals from reception system signals, and sends a transmitting signal from an adder circuit 912 to the telephone line 92a by way of the NCU 92. In addition, it receives a signal from the other end by way of the NCU 92, and sends it to a demodulation unit 98 by way of a signal line 96a.

The modulation/demodulation unit 98 is a modulation/demodulation unit for performing modulation and demodulation based on the ITU-T recommendation V. 8, V. 21, V. 27 ter, V. 29, V. 17 and V. 34, and each transmission mode is specified by control of a bus 926. The modulation/demodulation unit 98 inputs the transmitting signal from the bus 926, and outputs modulation data to the signal line 98a. In addition, it inputs a receiving signal outputted to the signal line 96a, and outputs demodulation data to the bus 926.

A caller circuit 910 inputs telephone number information according to the signal from the bus 926, and outputs a selection signal of DTMF to a signal line 910a.

An adder circuit 912 inputs information of the signal line 98a and the signal line 910a, and outputs added results to a signal line 912a.

A read circuit 914 outputs read data to the bus 926.

A record circuit 916 sequentially records the information outputted to the bus 926 line by line.

A memory 918 is used to store the memory (RAM) for work and in addition, raw information of the read data or encoded information and also to store received information or decoded information via the bus 926.

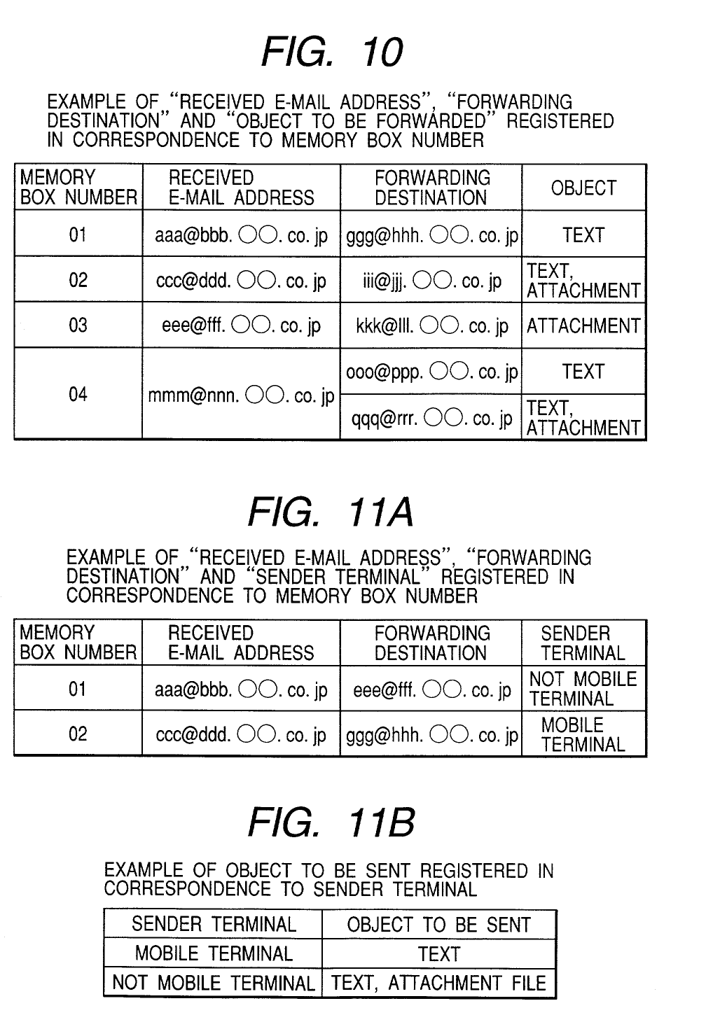

FIG. 10 is a diagram showing examples of “Received e-mail address”, “Forwarding destination” and “Object to be forwarded” registered in correspondence to memory box numbers in this embodiment.

The memory 918 has the memory for storing the received e-mail addresses, forwarding destinations and objects to be forwarded in correspondence to memory box numbers, which are registered via the bus 926 as shown in FIG. 10 for instance.

An operation unit 920 has a one touch dial, a compact dial, a ten key, a * key, a # key, a start key, a stop key, a set key, an e-mail transmission selection key, a key for registration with the memory 918 and other function keys, and any pressed key information is outputted to the bus 926. The operation unit 920 has a display unit for inputting and displaying the information outputted to the bus 926.

A CPU (Central Processing Unit) 922 controls the entire facsimile apparatus FS 91 and performs a facsimile transmission control procedure, and its control program is stored in a ROM 924.

A service provider 928 is connected to a PSTN 930 via a signal line 928a, and to the Internet 932 via a signal line 928b.

The control program stored in the ROM 924 is the control program wherein, in the facsimile apparatus capable of facsimile communication via the Internet, means for registering received e-mail addresses and the process to be executed next is implemented in correspondence to a memory box, and as the process to be executed next, the object to be sent of the received information is changed according to conditions when setting forwarding to a specific destination.

In addition, the above control program is the program capable of selecting, as the transmission of the received information to the next destination, one of transmitting only the text, transmitting only the attachment file, and transmitting the text and the attachment file.

Here, the above control program is the program wherein means for registering a plurality of destinations as the destinations to send the received information in correspondence to the memory box is implemented, and when transmitting the received information to these plurality of destinations, the object to be sent can be changed among transmitting only the text, transmitting only the attachment file, and transmitting the text and the attachment file.

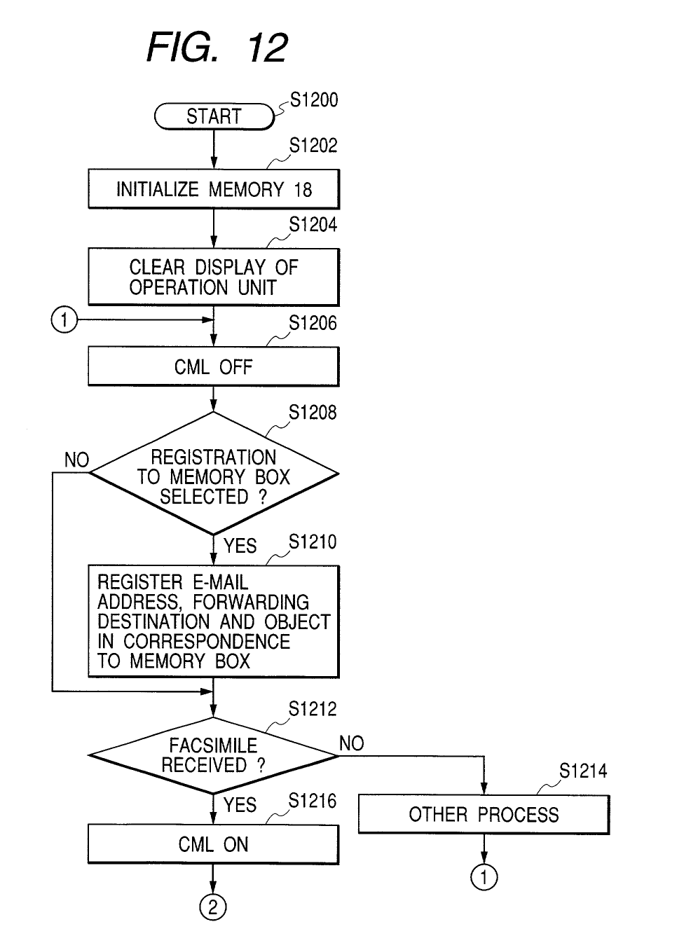

FIGS. 12, 13 and 14 are the flowcharts showing the operation of this embodiment.

The memory 918 is initialized via the bus 926 in a step S1202, the display unit of the operation unit is cleared via the bus in a step S1204, and the CML of the NCU 92 is turned off via the bus in a step S1206.

It is determined whether or not the registration with the memory box is selected via the bus 926 in a step S1208, and it proceeds to a step S1210 if the registration is selected, and it registers via the bus 926 the received e-mail addresses, forwarding destinations and objects to be forwarded in correspondence to memory box numbers with the memory 918 as shown in FIG. 10 for instance, and it proceeds to a step S1212 if the registration is not selected.

It is determined whether or not facsimile reception is started in the step S1212, and it proceeds to a step S1216 if the facsimile reception is started, and it proceeds to a step S1214 to execute other processes if the facsimile reception is not started.

It determines a received signal in a step S1302, and it proceeds to a step S1304 if a G3 protocol signal of the facsimile is detected, and it proceeds to a step S1310 if a PPP (Point to Point) protocol signal is detected.

It performs a pre-procedure of the G3 protocol in the step S1304, it receives and records an image signal in a step S1306, and it performs a post-procedure in a step S1308. It performs the PPP protocol in a step S1310, and it receives and prints the text and the attachment file based on the ITU-T recommendation T. 37 in a step S1312, and it turns off the CML of the NCU 92 via the bus 926 in a step S1314.

It determines whether or not the received e-mail address is registered with the applicable memory shown in FIG. 10 in a step S1316, and it proceeds to the step S1316 if registered, and it proceeds to a step S1318 to erase memory-received information from the memory if not registered.

It waits for 30 seconds in a step S1320, and it turns on the CML of the NCU 92 via the bus 926 in a step S1322, and it uses the caller circuit to call the service provider via the bus 926 in a step S1324 and performs the PPP protocol and posts the e-mail address for transmission in a step S1402.

As in FIG. 10, it sends to the destination registered in correspondence to the received e-mail address the object (the text, the text and the attachment file, the attachment file) registered in correspondence to the destination based on the ITU-T recommendation T. 37 in a step S1404.

It is determined whether or not there is a destination yet to be forwarded to in the step S1406, and it proceeds to the step S1408 if there is one, and it proceeds to the step S1206 if there is none.

In the step S1408, it turns off the CML of the NCU 92 via the bus 926 and proceeds to the step S1320.

As above, according to this embodiment, it is possible to set a mailbox to the mail address and specify the destination of the received data in correspondence to it. In addition, the object to be forwarded can be set for each destination.

(Third Embodiment)

A third embodiment is the embodiment wherein, in the second embodiment, it has means for setting whether or not the destination is a mobile terminal, and according to this information, the object to be sent can be changed among only the text, only the attachment file, and the text and the attachment file when transmitting the received information.

Here, it has means for registering only the text, only the attachment file, or the text and the attachment file as the information to be sent in correspondence to whether or not the destination is mobile, and it determines whether only the text, only the attachment file, or the text and the attachment file should be the object to be sent to the next destination based on this registered information.

In the third embodiment, the following information is registered in the memory 918.

In the memory 918, there is the memory for storing the received e-mail address, the forwarding destination and a sender terminal (whether a mobile terminal or not) in correspondence to the memory box number, which are registered via the bus 926 as shown in FIG. 11A for instance.

In the memory 918, there is the memory for registering in the concrete only the text, only the attachment file, or the text and the attachment file as the object to be sent in correspondence to the sender terminal (whether a mobile terminal or not), which is registered via the bus 926 as shown in FIG. 11B for instance.

Next, operation of a third embodiment will be described.

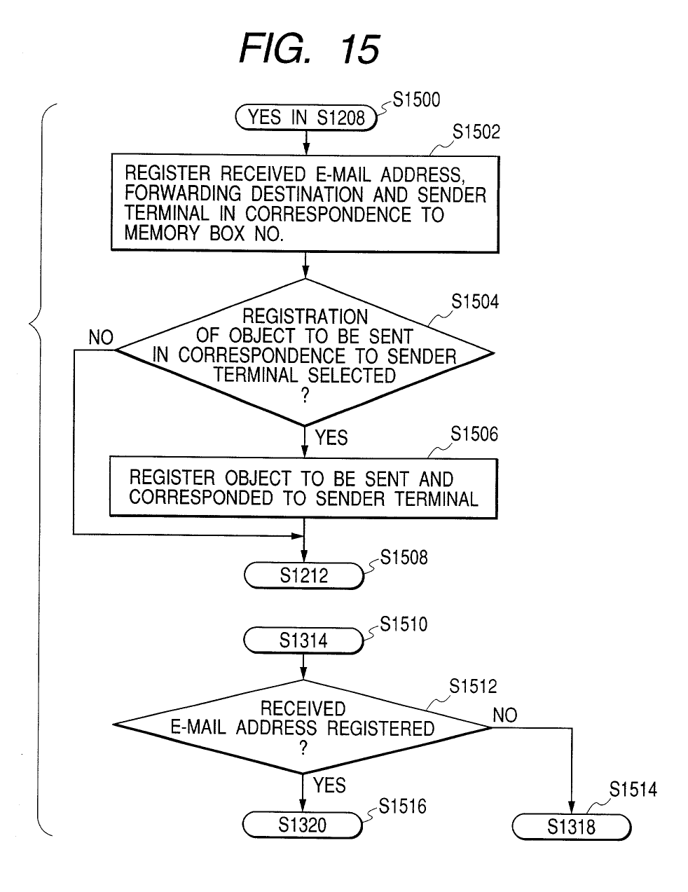

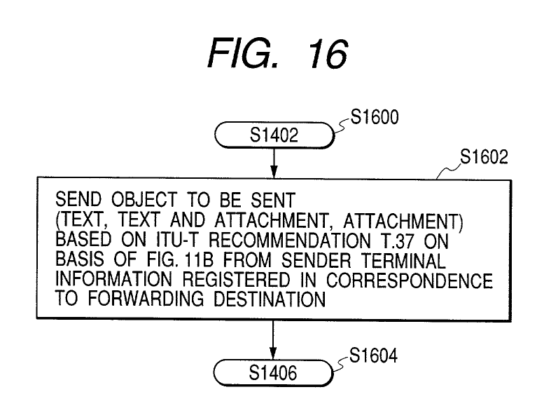

FIGS. 15 and 16 are the flowcharts showing the operation of the third embodiment.

FIGS. 15 and 16 show portions wherein the third embodiment is different from the flowcharts showing the operation of the second embodiment.

A step S1500 represents YES of the step S1208 in FIG. 12, and the received e-mail address, the forwarding destination and the sender terminal in correspondence to the memory box number are registered in the memory 918 via the bus 926 as shown in FIG. 11A for instance in a step S1502.

In a step S1504, it is determined whether or not registration of the object to be sent in correspondence to the sender terminal is selected, and if the registration of the object is selected, it proceeds to a step S1506 to register the object via the bus 926 as shown in FIG. 11B for instance. And if the object to be sent in correspondence to the sender terminal is not selected, it proceeds to a step S1508 (step S1212 in FIG. 2).

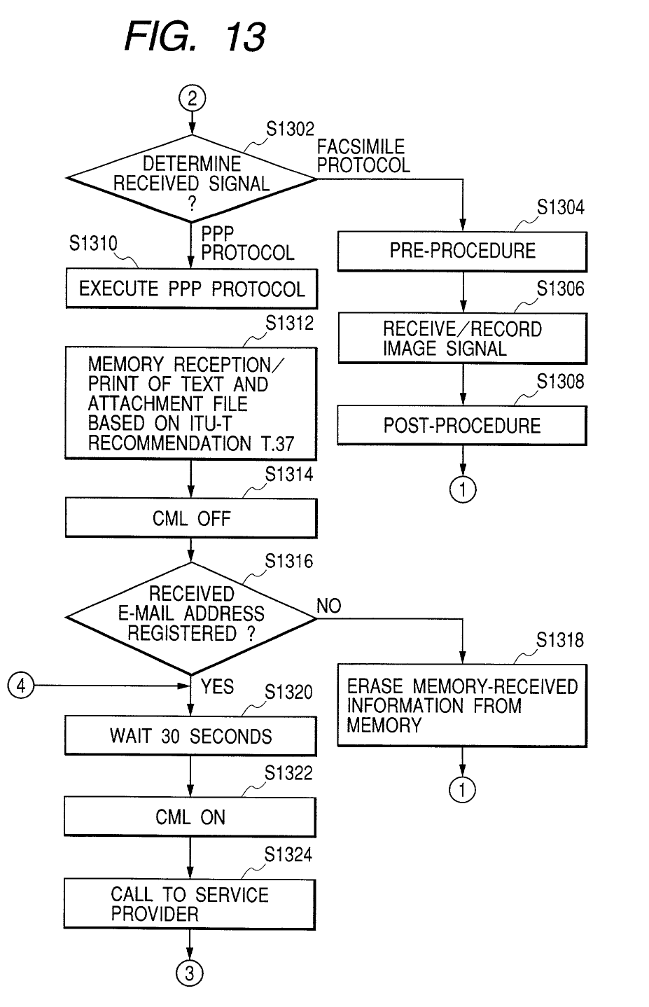

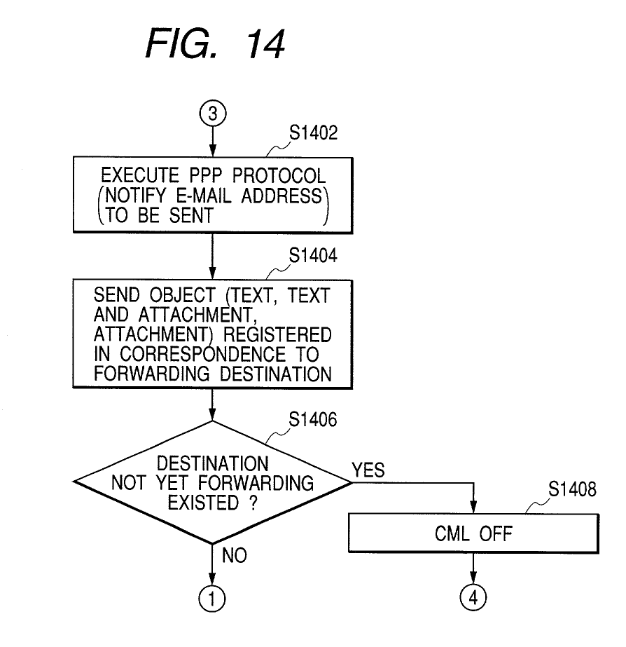

A step S1510 represents the step S1314 in FIG. 13, and it is determined whether or not the received e-mail address is registered in the applicable memory in FIG. 11A in a step S1512, and it proceeds to a step S1516 (step S1320 in FIG. 13) if registered, and it proceeds to a step S1514 (step S1318 in FIG. 13) to erase memory-received information from the memory if not registered.

A step S1600 represents the step S1402 in FIG. 14, and it sends to the destination registered in correspondence to the received e-mail address the object to be sent (the text, the text and the attachment file, the attachment file) based on the registered object shown in FIG. 11B from the sender terminal information registered in correspondence to the destination based on the ITU-T recommendation T. 37 in a step S1602.

A step S1604 represents the step S1406 in FIG. 14.

According to this embodiment, it is possible to set the object to be sent according to the type of a destination terminal. Accordingly, in the case of changing the setting, a change can be made more easily than to modify the object to be sent for each forwarding destination. In addition, according to the second and third embodiments, the facsimile apparatus capable of the facsimile communication via the Internet has the means for registering the received e-mail addresses and the process to be executed next in correspondence to the memory box, and as the process to be executed next, transmission of the received information can be changed according to the conditions when setting the forwarding to the specific destination.

In addition, in the case of transmitting the received information to the next destination, it possible to select one of transmitting only the text, transmitting only the attachment file, and transmitting the text and the attachment file.

Furthermore, it has the means for registering a plurality of destinations as the destinations to send the received information in correspondence to the memory box, and when transmitting the received information to these plurality of destinations, the object to be sent can be changed among transmitting only the text, transmitting only the attachment file, and transmitting the text and the attachment file.

It becomes possible thereby, on the terminal for implementing the facsimile communication via the Internet, to transmit only the text, only the attachment file, or the text and the attachment file by destination when facsimile-transmitting via the Internet the information facsimile-received via the Internet, allowing appropriate information to be sent in correspondence to the destinations so that it is very user-friendly.

In addition, it has the means for setting whether or not the destination is the mobile terminal, and it is possible, when sending the received information, to change transmission among only the text, only the attachment file, and the text and the attachment file according to whether or not it is the mobile information.

Furthermore, it has the means for registering only the text, only the attachment file, and the text and the attachment file as the information to be sent according to whether or not the destination is mobile, and is capable of, based on this registered information, determining the transmission to the next destination to be whether only the text, only the attachment file or the text and the attachment file.

It thereby allows appropriate information to be sent according to whether or not the destination is the mobile terminal so that it is very user-friendly.

Moreover, the above embodiment can be applied to an image communication apparatus other than the facsimile apparatus, such as a personal computer having an image communication function.

In addition, it is needless to say that the present invention is also applicable in the case where it is attained by supplying the program to a system or an apparatus with a storage medium storing a program module of software for implementing the above-mentioned embodiment. In this case, the program module itself that is read from the storage medium implements the new function of the present invention, and the storage medium storing the program constitutes the present invention.

While the program module is stored in the memory in the communication terminal equipment in the above embodiment, the storage medium for supplying the program module may be various media such as a floppy disk, a hard disk, an optical disk, a magneto-optical disk, a CD-ROM, an MO, a CD-R, a DVD, a magnetic tape and a nonvolatile memory card. However, it is not necessary to limit it to any specific medium since it is sufficient to be capable of storing the above program.

What is claimed is:

1. A communication apparatus comprising:
reception means for receiving data;
conversion means for converting the received data into electronic mail; and
transmission means for transmitting the electronic mail converted by said conversion means to be forwarded to a plurality of destinations.

2. The communication apparatus according to claim 1, wherein said conversion means attaches an image received by said reception means to the electronic mail.

3. The communication apparatus according to claim 1, further comprising:
registration means for registering the plurality of destinations for said transmission means to transmit said electronic mail.

4. The communication apparatus according to claim 3, wherein said conversion means attaches the image received by said reception means to the electronic mail, and said registration means has a method of attaching said image registered for each destination.

5. The communication apparatus according to claim 4, wherein said method of attaching also includes information on whether or not to attach said image to the electronic mail.

6. The communication apparatus according to claim 4, wherein said method of attaching includes information on whether to attach all or a part of said received image.

7. The communication apparatus according to claim 4, wherein said method of attaching includes information on an encoding system of said attached image.

8. The communication apparatus according to claim 1, wherein said reception means receives said image based on a facsimile procedure.

9. The communication apparatus according to claim 8, wherein said facsimile procedure is based on the ITU-T T. 37 recommendation.

10. A communication apparatus comprising:
reception means for receiving data;
management means for managing a forwarding destination and setting on forwarding of received data for each mail address of the data received by said reception means; and
transmission means for transmitting the data received by said reception means as electronic mail based on information managed by said management means.

11. The communication apparatus according to claim 10, wherein said reception means executes a reception process based on the ITU-T T. 37 recommendation.

12. The communication apparatus according to claim 10, wherein said management means manages whether to transmit only the text, transmit only the attachment file or transmit both the text and the attachment file of said received data.

13. The communication apparatus according to claim 10, wherein said management means is capable of managing a plurality of said forwarding destinations for each address.

14. The communication apparatus according to claim 10, wherein said management means manages whether or not t he forwarding destination is a mobile terminal.

15. The communication apparatus according to claim 14, wherein said management means manages the setting in the case of forwarding to the mobile terminal.

16. A method of controlling a communication apparatus comprising:
a reception step of receiving data;
a conversion step of converting the received data into electronic mail; and
a transmission step of transmitting the electronic mail converted in said conversion step to be forwarded to a plurality of destinations.

17. A method of controlling a communication apparatus comprising:
a reception step of receiving data;
a management step of managing a forwarding destination and setting on forwarding of received data for each mail address of the data received in said reception step; and
a transmission step of transmitting the data received in said reception step as electronic mail based on information managed in said management step.

18. A storage medium storing a program for controlling a communication apparatus, said program having:
a reception step of receiving data;
a conversion step of converting the received data into electronic mail; and
a transmission step of transmitting the electronic mail converted in said conversion step to be forwarded to a plurality of destinations.

19. A storage medium storing a program for controlling a communication apparatus, said program having:
a reception step of receiving data;
a management step of managing a forwarding destination and setting on forwarding of received data for each mail address of the data received in said reception step; and
a transmission step of transmitting the data received in said reception step as electronic mail based on information managed in said management step.
